(19) United States
(12) Patent Application Publication
(10) Pub. No.: US 2026/0145464 A1
(43) Pub. Date: May 28, 2026

(54) TIRE

(71) Applicant: TOYO TIRE CORPORATION, HYOGO (JP)

(72) Inventor: Masaru KOIKE, HYOGO (JP)

(21) Appl. No.: 19/399,129

(22) Filed: Nov. 24, 2025

(30) Foreign Application Priority Data
Nov. 26, 2024 (JP) 2024-205748

(51) Int. Cl. B60C 11/01; B60C 13/00

(52) U.S. Cl. CPC B60C 11/01; B60C 13/002; B60C 2011/013

(57) ABSTRACT

A tire 100 according to this invention includes a tread 1 and shoulders 2 that are arranged on outsides of the tread 1 in a tire axial direction. A protector 21 is or protectors 21 are formed on each or one of the shoulders 2, and the protector or each of the protectors includes a pair of circumferential portions 211 and 212 that extend in a tire circumferential direction to be spaced from each other in a tire radial direction and protrude in a tire axial direction.

### BACKGROUND OF THE INVENTION

### Field of the Invention

The present invention relates to a tire.

### Description of the Background Art

Tires are known in the art. Such a tire is disclosed in Japanese Patent Laid-Open Publication No. JP 2021-003947, for example.

Japanese Patent Laid-Open Publication No. JP 2021-003947 discloses a tire including a tread and sidewalls each extending inwardly in a tire radial direction from the tread. At least one of the sidewalls of such a tire includes a protector protruding in a tire axial direction.

In the tire disclosed in Japanese Patent Laid-Open Publication No. JP 2021-003947, the protector formed on the sidewall can protect the sidewall even when the sidewall rubs against a curb or similar object. However, in the tire disclosed in Japanese Patent Laid-Open Publication No. JP 2021-003947, it is difficult to effectively protect a shoulder, which is positioned on the tread side of the tire relative to the sidewall and on the outside of the tread in the tire axial direction. For this reason, it is desirable to effectively protect the shoulder positioned between the tread and the sidewall in the tire axial direction.

### SUMMARY OF THE INVENTION

The present invention is intended to solve the above problems, and one object of the present invention is to provide a tire capable of effectively protecting a shoulder positioned between a tread and a sidewall in a tire axial direction.

In order to attain the aforementioned object, a tire according to the one aspect of the present invention includes a tread; and shoulders that are arranged on outsides of the tread in a tire axial direction, wherein a protector is or protectors are formed on each or one of the shoulders, and the protector or each of the protectors includes a pair of circumferential portions that extend in a tire circumferential direction to be spaced from each other in a tire radial direction and protrude in a tire axial direction.

In the tire according to the one aspect of the present invention, as discussed above, a protector is or protectors are formed on each or one of the shoulders, and the protector or each of the protectors includes a pair of circumferential portions that extend in a tire circumferential direction to be spaced from each other in a tire radial direction and protrude in a tire axial direction. Accordingly, when the shoulder comes into contact with a curb or other object while the tire is rotating, the pair of circumferential portions, which protrude in the tire axial direction and are spaced from each other in the tire radial direction, rub against the curb, and as a result a stress caused by shoulder rubbing can be dispersed by the pair of circumferential portions. In addition, because the pair of circumferential portions are more likely to deform in the tire radial direction and to release such a stress as compared with a single large protrusion protruding in the tire circumferential direction, the protector itself or the protectors themselves are unlikely to be damaged. From these viewpoints, it is possible to effectively prevent damage to the shoulder when it comes in contact with a curb or other object. Therefore, it is possible to effectively protect the shoulder positioned between the tread and a sidewall in the tire axial direction.

In the tire according to the aforementioned one aspect, it is preferable that the protector or each of the protectors further includes a radial portion that extends in the tire radial direction to connect one ends in the tire circumferential direction of the pair of circumferential portions to each other and protrudes in the tire axial direction. According to this configuration, because the pair of circumferential portions are connected by the radial portion, it is possible to improve the mechanical strength (rigidity) of the pair of circumferential portions. In addition, when the shoulder rubs against a curb in the tire radial direction, the radial portion can rub against the curb, effectively protecting the shoulder.

In the aforementioned configuration of the tire in which the protector or each of the protectors includes the radial portion, it is preferable that the protector or each of the protectors is formed by a hook-shaped protrusion that is defined by the pair of circumferential portions and the radial portion, and opens in the tire circumferential direction. According to this configuration, the hook-shaped protector, which opens in the tire circumferential direction, can effectively protect the shoulder against rubbing of the shoulder with a curb both in the tire circumferential direction and the tire radial direction.

In the aforementioned configuration of the tire in which the protector or each of the protectors includes the radial portion, it is preferable that the protector or each of the protectors is formed by a roughly U-shaped protrusion that is defined by the pair of circumferential portions and the radial portion, and opens in the tire circumferential direction. According to this configuration, the protector or each of the protectors can be easily deformed, and the roughly U-shaped protector can appropriately release and effectively disperse a stress caused by rubbing as compared with a case where the protector is formed in a single large rectangular-shaped protrusion. As a result, it is possible to more effectively protect the shoulder.

In the tire according to the aforementioned one aspect, it is preferable that the pair of circumferential portions included in the protector or each of the protectors are a first circumferential portion arranged on an inner side in the tire radial direction and a second circumferential portion arranged on an outer side in the tire radial direction; a length in the tire circumferential direction of the first circumferential portion is greater than a length in the tire circumferential direction of the second circumferential portion; and another end of the first circumferential portion further protrudes in the tire circumferential direction relative to another end of the second circumferential portion. According to this configuration, a longer area in the tire circumferential direction of the shoulder can be protected by the first circumferential portion, which is longer than the second circumferential portion and whose another end further protrudes relative to the second circumferential portion in the tire circumferential direction.

In the aforementioned configuration of the tire in which the protector or each of the protectors includes the radial portion, it is preferable that the pair of circumferential portions included in the protector or each of the protectors are a first circumferential portion arranged on an inner side in the tire radial direction and a second circumferential portion arranged on an outer side in the tire radial direction; and a length in the tire radial direction of the radial portion is smaller than a length in the tire circumferential direction of the first circumferential portion and a length in the tire circumferential direction of the second circumferential portion. According to this configuration, because an increase in the length in the tire radial direction of the protector can be prevented, it is possible to arrange the protector in balance on the shoulder, which has a length in the tire radial direction smaller than its length in the tire circumferential direction.

In the tire according to the aforementioned one aspect, it is preferable that the pair of circumferential portions included in the protector or each of the protectors are a first circumferential portion arranged on an inner side in the tire radial direction and a second circumferential portion arranged on an outer side in the tire radial direction; and a length in the tire radial direction of a part on another end side of the first circumferential portion is greater than a length in the tire radial direction of the second circumferential portion. According to this configuration, it is possible to improve the mechanical strength (rigidity) of the first circumferential portion in the part on the another end side of the first circumferential portion whose length in the tire radial direction is greater.

In this configuration, it is preferable that a part on the another end side of the first circumferential portion included in the protector or each of the protectors protrudes further inward in the tire radial direction relative to a part on one end side of the first circumferential portion. According to this configuration, because the part on the another end side of the first circumferential portion can be positioned further inward in the tire radial direction relative to the part on the one end side of the first circumferential portion, the protector can protect the shoulder in a wide area in the tire radial direction.

In the aforementioned configuration of the tire in which the protector or each of the protectors includes the radial portion, it is preferable that the pair of circumferential portions included in the protector or each of the protectors includes a second circumferential portion arranged on an outer side in the tire radial direction; and a length in the tire circumferential direction of the radial portion is greater than a length in the tire radial direction of the second circumferential portion. According to this configuration, because the length in the tire circumferential direction of the radial portion is greater than a length in the tire circumferential direction of the second circumferential portion, the pair of circumferential portions and the radial portion can more effectively protect the shoulder from rubbing in the tire circumferential direction.

In the tire according to the aforementioned one aspect, it is preferable that the protectors are arranged between lug grooves formed on the shoulder in the tire circumferential direction. According to this configuration, the protectors can more effectively protect parts of the shoulder separated from each other by the lug grooves.

In this configuration, it is preferable that the protectors are formed on the shoulder within ranges from a ground contact edge of the tread to edges of the lug grooves. According to this configuration, the protectors can more effectively protect the shoulder in the area from the ground contact edge of the tread to the edges of the lug grooves.

In the tire according to the aforementioned one aspect, it is preferable that the protector or each of the protectors has a protruding thickness from not smaller than 0.5 mm to not greater than 2 mm the tire axial direction. According to this configuration, the protector or the protectors having a thickness not smaller than 0.5 mm can more effectively protect the shoulder. In addition, the protector or the protectors can be prevented from excessively protruding from the shoulder by setting the thickness of the protector or each of the protectors to be not greater than 2 mm.

According to the present invention, it is possible to effectively protect a shoulder positioned between a tread and a sidewall in a tire axial direction.

### BRIEF DESCRIPTION OF THE DRAWINGS

FIG. 1 is a perspective view showing a tire according to an embodiment of the present invention.

FIG. 2 is a schematic cross-sectional view of the tire taken along a line II-II in FIG. 1.

FIG. 3 is a view showing a tread and a shoulder of the tire according to the embodiment of the present invention.

FIG. 4 is a view showing protectors on the shoulder of the tire according to the embodiment of the present invention.

FIG. 5 is a view showing a protector on a shoulder of a tire according to a first modified example of the embodiment.

FIG. 6 is a view showing a protector on a shoulder of a tire according to a second modified example of the embodiment.

FIG. 7 is a view showing a protector on a shoulder of a tire according to a third modified example of the embodiment.

FIG. 8 is a view showing a protector on a shoulder of a tire according to a fourth modified example of the embodiment.

FIG. 9 is a view showing a protector on a shoulder of a tire according to a fifth modified example of the embodiment.

### DESCRIPTION OF THE PREFERRED EMBODIMENT

The following description will describe embodiments embodying the present invention with reference to the drawings.

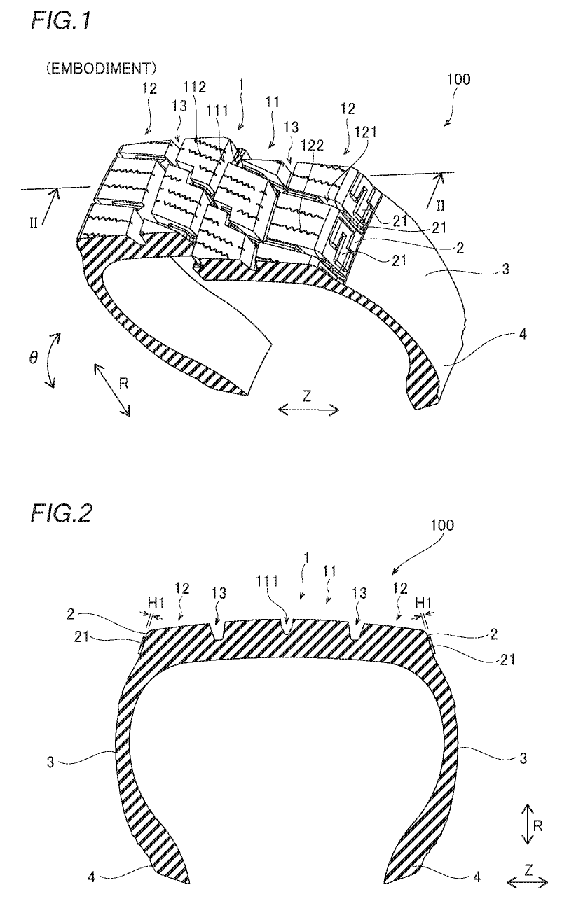

The following description describes a configuration of a tire 100 according to an embodiment of the present invention with reference to FIGS. 1 to 4.

As shown in FIGS. 1 and 2, the tire 100 is configured to be mounted on a wheel and to support a load using air pressure, with its interior being filled with air. In other words, the tire 100 is an inflated tire. In addition, the tire 100 is installed on a moving body via the wheel to rotate about an axis of rotation. For example, the moving body is a vehicle such as a passenger car, truck, or bus. for example, the vehicle is moved when driven by a drive mechanism that includes at least one of an engine or an electric motor.

For example, the tire 100 is an all-season tire used throughout the year, including both snow-free summer months and snowy winter months.

The tire 100 includes a tread 1, shoulders 2, sidewalls 3, and beads 4. The tread 1 is a part that comes into contact with the ground and has an uneven tread pattern having protruding/recessed shapes on its outer surface. The shoulders 2 are connected to the tread 1 and form outermost side surfaces of the tire 100. The sidewalls 3 are connected to the shoulders 2 and form side surfaces of the tire 100. The bead 4 is configured to be in contact with the wheel and to secure the tire 100 to the wheel.

### Composition of Tread

The tread 1 includes center blocks 11, shoulder blocks 12, and circumferential grooves 13 between the center blocks 11 and the shoulder blocks 12, as shown in FIGS. 1 and 2.

The center blocks 11 are arranged between the pair of shoulder blocks 12. In other words, the center blocks 11 are arranged in a central part of the tread 1 in the tire axial direction (Z direction).

A circumferential groove 111 is arranged between the center blocks 11 so that the center blocks 11 are separated from each other in the tire axial direction (Z direction). In addition, each of the center blocks 11 has sipes 112. The sipes 112 are formed to be connected to the circumferential groove 111 or one of the circumferential grooves 13. In addition, the sipes 112 are formed in a zigzag shape. The sipes 112 are also grooves formed in the center blocks 11.

The pair of shoulder blocks 12 are arranged on the outer sides of the tread 1 in the tire axial direction (Z direction). In other words, the shoulder blocks 12 are arranged on the shoulder 2 sides (both outer sides in the Z direction) of the tread 1.

The shoulder blocks 12 include shoulder slits 121 extending from the circumferential grooves 13 outward in the tire axial direction to be inclined and to divide the shoulder blocks 12. In addition, each of the shoulder blocks 12 has sipes 122. The shoulder sipes 122 are connected to the circumferential groove 13 and formed to extend at the same inclination angle as the shoulder slits 121. The sipes 122 are also formed in a zigzag shape extending along the direction defined by the inclination angle. The sipes 122 are also grooves formed in the shoulder blocks 12.

### Configuration of Shoulder

The shoulders 2 are arranged on the outer sides of the tread 1 in the tire axial direction (Z direction). In other words, the shoulders 2 are arranged between the shoulder block 12 of the tread 1 and the sidewalls 3 in the tire axial direction. Each of the shoulders 2 includes protectors 21 that protrude in the tire axial direction (Z-direction), as shown in FIGS. 1 to 3. The protectors 21 are configured to protect one of the shoulders 2 when the shoulder 2 comes into contact with a convex part such as a curb. The protectors 21 are arranged on both the shoulders 2 on both sides of the tire in the tire axial direction.

In addition, each of the shoulder 2 includes lug grooves 22 that extend in the tire radial direction (R direction) and to divide the shoulder 2 in the tire circumferential direction (θ direction). The lug grooves 22 are connected to the shoulder slits 121 in the shoulder block 12 of the tread 1.

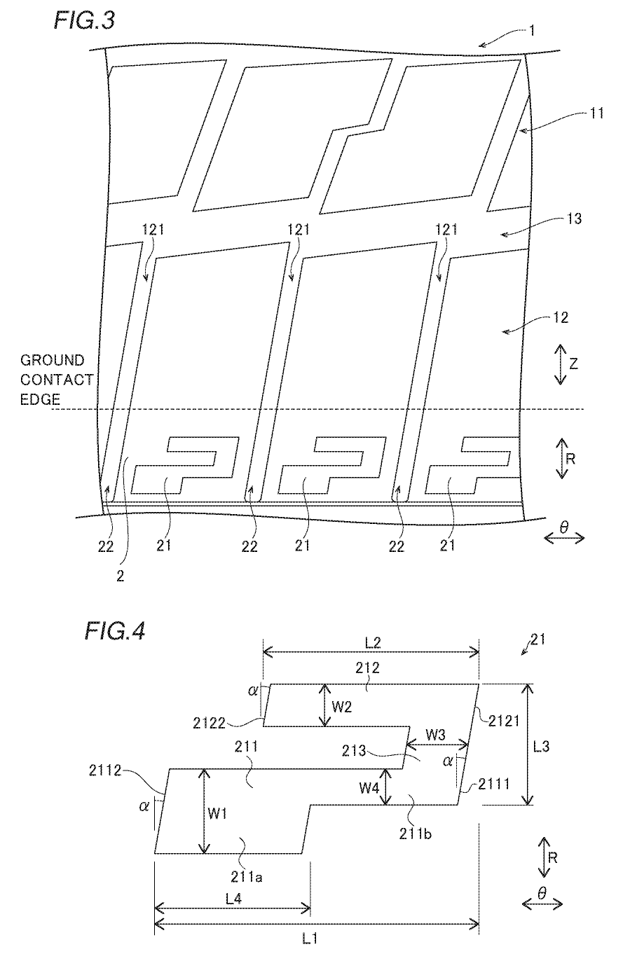

Here, in this embodiment, as shown in FIG. 4, each of the protectors 21 includes a pair of circumferential portions (first circumferential portion 211 and second circumferential portion 212) that extend in the tire circumferential direction (θ direction) and to be spaced from each other in the tire radial direction (R direction) and protrude in the tire axial direction (Z direction). The first circumferential portion 211 is arranged on the inner side in the tire radial direction relative to the second circumferential portion 212. In other words, the second circumferential portion 212 is arranged on the outer side in the tire radial direction relative to the first circumferential portion 211.

As shown in FIG. 4, the protector 21 includes a radial portion 213 that extends in the tire radial direction (R direction) to connect one ends in the tire circumferential direction (θ direction) of the pairs of circumferential portions (first circumferential portion 211 and second circumferential portion 212) and protrude in the tire axial direction (Z direction). Specifically, the radial portion 213 connects one end 2111 of the first circumferential portion 211 to one end 2121 of the second circumferential portion 212.

Specifically, as shown in FIG. 4, each of the protectors 21 includes a hook-shaped protrusion that is defined by a corresponding one of the pairs of circumferential portions and a corresponding one of the radial portions, and opens in the tire circumferential direction (θ direction). In other words, each of the protectors 21 is formed by the roughly U-shaped protrusion, which opens in the tire circumferential direction (θ direction).

As shown in FIG. 2, the protectors 21 are formed to protrude in the tire axial direction (Z direction). The protectors 21 are formed with a protruding thickness H1 in the tire axial direction. For example, the protectors 21 have a protruding thickness H1 from not smaller than 0.5 mm to not greater than 2 mm the tire axial direction.

As shown in FIG. 4, both edges in the tire circumferential direction (θ direction) of the protector 21 are inclined at an angle α with respect to the tire radial direction (R direction). Specifically, another end 2112 of the first circumferential portion 211 of the protector 21 is inclined at the angle α with respect to the tire radial direction (R direction). Also, another end 2122 of the second circumferential portion 212 is inclined at the angle α with respect to the tire radial direction (R direction). In addition, one end 2111 of the first circumferential portion 211, one end 2121 of the second circumferential portion 212 and the radial portion 213 are inclined at the angle α with respect to the tire radial direction (R direction). For example, the angle α is not greater than 30 degrees.

As shown in FIG. 4, each of the protectors 21 is formed such that a length L1 in the tire circumferential direction (θ direction) of the first circumferential portion 211, which is positioned on the inner side in the tire radial direction (R direction) in the pair of circumferential portions (first circumferential portion 211 and second circumferential portion 212), is greater than a length L2 of the second circumferential portion 212, which is positioned on the outer side in the tire radial direction. That is, length L1 > length L2.

Also, as shown in FIG. 4, the another end 2112 of the first circumferential portion 211 included in the protector 21 further protrudes relative to the another end 2122 of the second circumferential portion 212 in the tire circumferential direction (θ direction). In other words, the protector 21 is formed such that the first circumferential portion 211 further protrudes relative to the second circumferential portion 212 on the another end side opposite to the one end where the radial portion 213 is arranged in the tire circumferential direction (θ direction).

Also, as shown in FIG. 4, each of the protectors 21 is formed such that a length L3 in the tire radial direction (R direction) of the radial portion 213 is smaller than the length L1 in the tire circumferential direction (θ direction) of the first circumferential portion 211, which is positioned on the inner side in the tire radial direction (R direction) in the pair of circumferential portions (first circumferential portion 211 and second circumferential portion 212), and the length L2 in the tire circumferential direction of the second circumferential portion 212, which is positioned on the outer side in the tire radial direction. That is, length L1 > length L2 > length L3.

Also, as shown in FIG. 4, each of the protectors 21 is formed such that a length W1 in the tire radial direction of a part 211a on the another end 2112 side of the first circumferential portion 211, which is positioned on the inner side in the tire radial direction (R direction) in the pair of circumferential portions (first circumferential portion 211 and second circumferential portion 212), is greater than a length W2 in the tire radial direction of the second circumferential portion 212, which is positioned on the outer side in the tire radial direction. Also, the first circumferential portion 211 is formed such that a length W1 in the tire radial direction of the part 211a on the another end 2112 side is greater than a length W4 in the tire radial direction of a part 211b on the one end 2111 side. For example, the length W1 is not less than twice the length W4.

In other words, the part 211a on the another end 2112 side of the first circumferential portion 211 included in the protector 21 protrudes further inward in the tire radial direction (R direction) relative to the part 211b on the one end 2111 side of the first circumferential portion 211.

Also, as shown in FIG. 4, the protector 21 is formed such that a length L4 in the tire circumferential direction (θ direction) of the part 211a on the another end 2112 side of the first circumferential portion 211 is smaller than the length L2 in the tire circumferential direction of the second circumferential portion 212. That is, length L1 > length L2 > length L4.

Also, as shown in FIG. 4, the protector 21 is formed such that the positional range of the part 211a on the another end 2112 side of the first circumferential portion 211 overlaps the positional range of the second circumferential portion 212 in the tire circumferential direction (θ direction).

Also, as shown in FIG. 4, the protector 21 is formed such that the length W3 in the tire circumferential direction (θ direction) of the radial portion 213 is greater than the length W2 in the tire radial direction (R direction) of the second circumferential portion 212, which is positioned on the outer side in the tire radial direction in the pair of circumferential portions (first circumferential portion 211 and second circumferential portion 212). Also, the protector 21 is formed such that the length W3 in the tire circumferential direction of the radial portion 213 is greater than the length W4 in the tire radial direction of the part 211b on the one end 2111 side of the first circumferential portion 211, which is positioned on the inner side in the tire radial direction in the pair of circumferential portions (first circumferential portion 211 and second circumferential portion 212). Also, the protector 21 is formed such that the length W3 in the tire circumferential direction of the radial portion 213 is smaller than the length W1 in the tire radial direction of the part 211a on the another end 2112 side of the first circumferential portion 211, which is positioned on the inner side in the tire radial direction in the pair of circumferential portions (first circumferential portion 211 and second circumferential portion 212). That is, length W1 > length W3 > length W2 > length W4.

Here, as shown in FIGS. 1 and 3, the protectors 21 are arranged between the lug grooves 22 formed on the shoulder 2 in the tire circumferential direction (θ direction). Also, all of the protectors 21 are formed in the same shape as each other. In addition, the protectors 21 are formed on the shoulder 2 within ranges from a ground contact edge of the tread 1 to edges of the lug grooves 22.

Also, as shown in FIG. 1, the positional range of the protector 21 overlaps the positions of the sipes 122 of the shoulder block 12 in the tire circumferential direction (θ direction).

### Advantages of the Embodiment

In this embodiment, the following advantages are obtained.

In this embodiment, as discussed above, each of the protectors 21 is formed in the shoulder 2 to include a pair of circumferential portions (first circumferential portion 211 and second circumferential portion 212) that extend in the tire circumferential direction (θ direction) and to be spaced from each other in the tire radial direction (R direction) and protrude in the tire axial direction (Z direction). Accordingly, when the shoulder 2 comes into contact with a curb or other object while the tire 100 is rotating, the pairs of circumferential portions (first and second circumferential portions 211 and 212), which protrude in the tire axial direction and are spaced from each other in the tire radial direction, rub against the curb, and as a result a stress caused by shoulder 2 rubbing can be dispersed by the pairs of circumferential portions (first and second circumferential portions 211 and 212). In addition, because the pairs of circumferential portions (first and second circumferential portions 211 and 212) are more likely to deform in the tire radial direction and to release such a stress as compared with a single large protrusion protruding in the tire circumferential direction, the protectors 21 themselves are unlikely to be damaged. For these reasons, it is possible to effectively prevent damage to the shoulder 2 even when the shoulder comes into contact with such a curb or other object. Therefore, it is possible to effectively protect the shoulder 2 positioned between the tread 1 and the sidewall 3 in the tire axial direction.

Also, in this embodiment, as discussed above, the protectors 21 include radial portions 213 that extend in the tire radial direction (R direction) to connect one ends in the tire circumferential direction (θ direction) of the pairs of circumferential portions (first and second circumferential portions 211 and 212) and protrude in the tire axial direction (Z direction). Accordingly, because the pairs of circumferential portions (first and second circumferential portions 211 and 212) are connected by the radial portions 213, it is possible to improve the mechanical strength (rigidity) of the pairs of circumferential portions (first and second circumferential portions 211 and 212). In addition, when the shoulder 2 rubs against a curb in the tire radial direction, the radial portion 213 can rub against the curb, effectively protecting the shoulder 2.

Also, in this embodiment, as discussed above, each of the protectors 21 is formed by a hook-shaped protrusion that is defined by a corresponding one of the pairs of circumferential portions and a corresponding one of the radial portions, and opens in the tire circumferential direction (θ direction). Accordingly, the hook-shaped protector 21, which opens in the tire circumferential direction, can effectively protect the shoulder 2 from rubbing of the shoulder 2 against a curb both in the tire circumferential direction and the tire radial direction (R direction).

Also, in this embodiment, as discussed above, each of the protectors 21 is formed by the roughly U-shaped protrusion, which opens in the tire circumferential direction (θ direction). Accordingly, the protectors 21 can be easily deformed and the roughly U-shaped protectors 21 can appropriately release and effectively disperse a stress caused by rubbing as compared with a case where each protector 21 is formed in a single large rectangular-shaped protrusion. As a result, it is possible to more effectively protect the shoulder 2.

Also, in this embodiment, as discussed above, each of the protectors 21 is formed such that a length L1 in the tire circumferential direction (θ direction) of the first circumferential portion 211, which is positioned on the inner side in the tire radial direction (R direction) in the pair of circumferential portions (first circumferential portion 211 and second circumferential portion 212), is greater than a length L2 of the second circumferential portion 212, which is positioned on the outer side in the tire radial direction. Also, the another end 2112 of the first circumferential portion 211 further protrudes relative to the another end 2122 of the second circumferential portion 212 in the tire circumferential direction. Accordingly, a longer area in the tire circumferential direction of the shoulder 2 can be protected by the first circumferential portion 211, which is longer than the second circumferential portion 212 and whose another end 2112 further protrudes relative to the second circumferential portion 212 in the tire circumferential direction.

Also, in this embodiment, as discussed above, each of the protectors 21 is formed such that a length L3 in the tire radial direction (R direction) of the radial portion 213 is smaller than the length L1 in the tire circumferential direction (θ direction) of the first circumferential portion 211, which is positioned on the inner side in the tire radial direction (R direction) in the pair of circumferential portions (first circumferential portion 211 and second circumferential portion 212), and the length L2 in the tire circumferential direction of the second circumferential portion 212, which is positioned on the outer side in the tire radial direction. Accordingly, because an increase in the length in the tire radial direction of the protector 21 can be prevented, it is possible to arrange protectors 21 in balance on the shoulder 2, which has a length in the tire radial direction smaller than its length in the tire circumferential direction.

Also, in this embodiment, as discussed above, each of the protectors 21 is formed such that a length W1 in the tire radial direction of a part 211a on the another end 2112 side of the first circumferential portion 211, which is positioned on the inner side in the tire radial direction (R direction) in the pair of circumferential portions (first circumferential portion 211 and second circumferential portion 212), is greater than a length W2 in the tire radial direction of the second circumferential portion 212, which is positioned on the outer side in the tire radial direction. Accordingly, it is possible to improve the mechanical strength (rigidity) of the first circumferential portion 211 in the part 211a on the another end 2112 side of the first circumferential portion 211 whose length in the tire radial direction is greater.

Also, in this embodiment, as discussed above, the part 211a on the another end 2112 side of the first circumferential portion 211 included in the protector 21 protrudes further inward in the tire radial direction (R direction) relative to the part 211b on the one end 2111 side of the first circumferential portion 211. Accordingly, because the part 211a on the another end 2112 side of the first circumferential portion 211 can be positioned further inward in the tire radial direction relative to the part 211b on the one end 2111 side of the first circumferential portion, the protector 21 can protect the shoulder 2 in a wide area in the tire radial direction.

Also, in this embodiment, as discussed above, the protector 21 is formed such that the length W3 in the tire circumferential direction (θ direction) of the radial portion 213 is greater than the length W2 in the tire radial direction (R direction) of the second circumferential portion 212, which is positioned on the outer side in the tire radial direction in the pair of circumferential portions (first circumferential portion 211 and second circumferential portion 212). According to this configuration, because the length W3 in the tire circumferential direction of the radial portion 213 is greater than a length in the tire circumferential direction of the second circumferential portion, the pair of circumferential portions (first circumferential portion 211 and second circumferential portion 212) and the radial portion 213 can more effectively protect the shoulder 2 from rubbing in the tire circumferential direction.

Also, in this embodiment, as discussed above, the protectors 21 are arranged between lug grooves 22 formed on the shoulder 2 in the tire circumferential direction (θ direction). Accordingly, the protectors 21 can more effectively protect parts of the shoulder 2 separated from each other by the lug grooves 22.

In addition, in this embodiment, the protectors 21 are formed on the shoulder 2 within ranges from a ground contact edge of the tread 1 to edges of the lug grooves 22. Accordingly, the protectors 21 can more effectively protect the shoulder 2 in the area from the ground contact edge of the tread 1 to the edges of the lug grooves 22.

Also, in this embodiment, as discussed above, the protectors 21 have a protruding thickness H1 from not smaller than 0.5 mm to not greater than 2 mm the tire axial direction (Z direction). Accordingly, the protectors 21 having a thickness not smaller than 0.5 mm can more effectively protect the shoulder 2. In addition, the protector 21 can be prevented from excessively protruding from the shoulder 2 by setting the thickness of the protectors 21 to be not greater than 2 mm.

### Modified Embodiments

Note that the embodiment disclosed this time must be considered as illustrative in all points and not restrictive. The scope of the present invention is not shown by the above description of the embodiments but by the scope of claims for patent, and all modifications (modified examples) within the meaning and scope equivalent to the scope of claims for patent are further included.

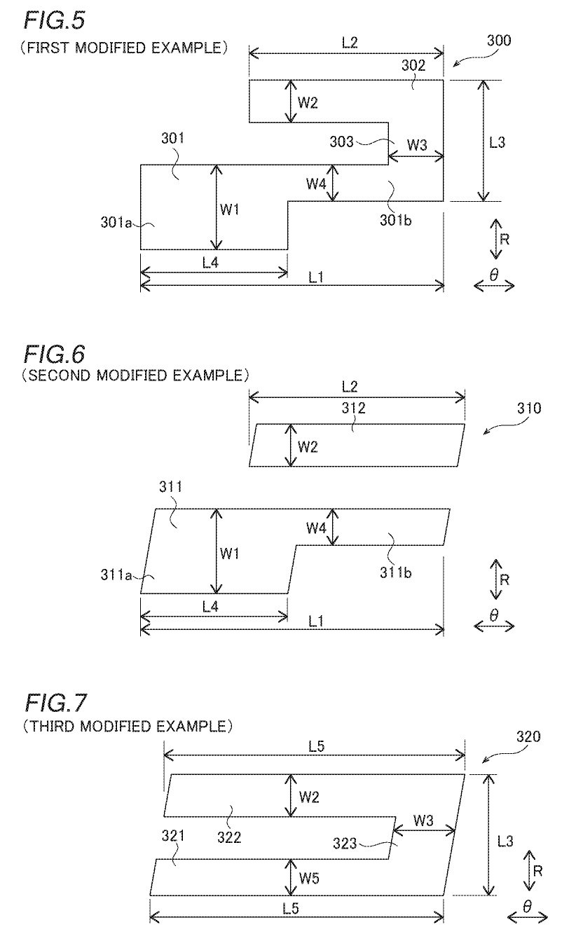

While the example in which both edges in the tire circumferential direction (θ direction) of the protector 21 are inclined at an angle α with respect to the tire radial direction (R direction) has been shown in the aforementioned embodiment, the present invention is not limited to this. In the present invention, as in a first modified example shown in FIG. 5, both edges in the tire circumferential direction (θ direction) of a protector 300 may not be inclined with respect to the tire radial direction (R direction). In the first modified example, the protector 300 includes a first circumferential portion 301, a second circumferential portion 302, and a radial portion 303, as shown in FIG. 5. Also, in the first modified example shown in FIG. 5, the dimensional relationship among length W1, length W2, length W3, and length W4 may be similar to that in the embodiment shown in FIG. 4. That is, the dimensional relationship can satisfy length W1 > length W3 > length W2 > length W4. Also, in the first modified example shown in FIG. 5, the dimensional relationship among length L1, length L2, length L3, and length L4 may be similar to that in the embodiment shown in FIG. 4. That is, the dimensional relationship may satisfy the condition: length L1 > length L2 > length L3. In addition, the dimensional relationship may satisfy the condition: length L1 > length L2 > length L4.

Also, while the example in which the protector 21 includes the radial portions 213 that connect one ends in the tire circumferential direction (θ direction) of the pairs of circumferential portions (first and second circumferential portions and 211 and 212) and protrude in the tire axial direction (Z direction) has been shown in the aforementioned embodiment, the present invention is not limited to this. In the present invention, as in a second example shown in FIG. 6, protector 310 may not have the radial portion. In the second modified example, the protector 310 includes a first circumferential portion 311 and a second circumferential portion 312, as shown in FIG. 6. Also, in the second modified example shown in FIG. 6, the dimensional relationship among the lengths W1, W2, and W4 may be similar to that in the embodiment shown in FIG. 4. That is, the dimensional relationship may satisfy the condition: length W1 > length W2 > length W4. Also, in the second modified example shown in FIG. 6, the dimensional relationship among the lengths L1, L2, and L4 may be similar to that in the embodiment shown in FIG. 4. That is, the dimensional relationship may satisfy the condition: length L1 > length L2 > length L4.

Also, while the example in which the part 211a on the another end 2112 side of the first circumferential portion 211 included in the protector 21 protrudes further inward in the tire radial direction (R direction) relative to the part 211b on the one end 2111 side of the first circumferential portion 211 has been shown in the aforementioned embodiment, the present invention is not limited to this. In the present invention, as in a third example shown in FIG. 7, a first circumferential portion 321 of a protector 320 may have a substantially constant length W5 in the tire radial direction (R direction). In the third modified example, the protector 320 includes the first circumferential portion 321, a second circumferential portion 322, and a radial portion 323, as shown in FIG. 7. Also, in the third modified example shown in FIG. 7, the dimensional relationship among length W2, length W3, and length W5 may satisfy the condition: length W3 > length W2 > length W5, similar to the embodiment shown in FIG. 4. In addition, the length W5 in the tire radial direction of the first circumferential portion 321 may be equal to the length W2 in the tire radial direction of the second circumferential portion 322. That is, the dimensional relationship may satisfy the condition: length W5 = length W2. In addition, the length L5 in the tire circumferential direction (θ direction) of the first circumferential portion 321 may be equal to the length L5 in the tire circumferential direction of the second circumferential portion 322.

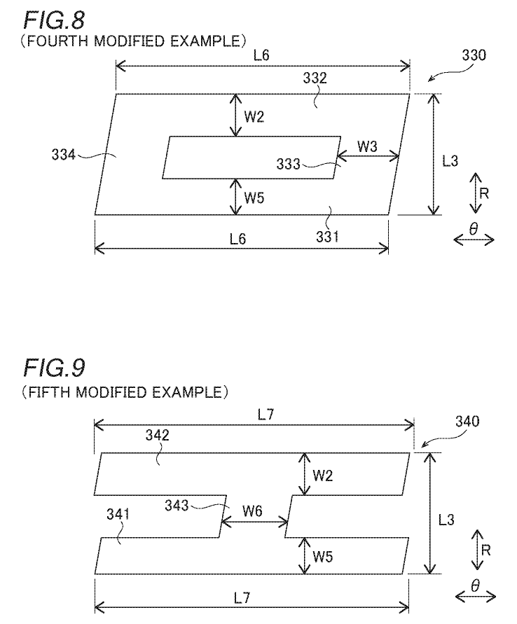

Also, while the example in which the protector 21 includes the radial portions 213 that connect one ends in the tire circumferential direction (θ direction) of the pairs of circumferential portions (first and second circumferential portions and 211 and 212) and protrude in the tire axial direction (Z direction) has been shown in the aforementioned embodiment, the present invention is not limited to this. In the present invention, as in a fourth modified example shown in FIG. 8, a protector 330 may include a first radial portion 333 that connects one ends in the tire circumferential direction (θ direction) of a pair of circumferential portions (first circumferential portion 331 and second circumferential portion 332), and a second radial portion 334 that connects another ends in the tire circumferential direction (θ direction) of the pair of circumferential portions (first circumferential portion 331 and second circumferential portion 332). In other words, the protector 330 may have a frame shape. In the fourth modified example, the protector 330 includes the first circumferential portion 331, the second circumferential portion 332, the first radial portion 333, and the second radial portion 334, as shown in FIG. 8. Also, in the fourth modified example shown in FIG. 8, the dimensional relationship among length W2, length W3, and length W5 may satisfy the condition: length W3 > length W2 > length W5, similar to the embodiment shown in FIG. 4. In addition, the length W5 in the tire radial direction of the first circumferential portion 331 may be equal to the length W2 in the tire radial direction of the second circumferential portion 332. That is, the dimensional relationship may satisfy the condition: length W5 = length W2. In addition, the length L6 in the tire circumferential direction (θ direction) of the first circumferential portion 331 may be equal to the length L6 in the tire circumferential direction of the second circumferential portion 332. In addition, the length L3 in the tire radial direction (R direction) of the first radial portion 333 and the second radial portion 334 may be smaller than the length L6 in the tire circumferential direction (θ direction) of the first circumferential portion 331 (length L6 in the tire circumferential direction of the second circumferential portion 332). That is, the dimensional relationship may satisfy the condition: length L3 < length L6.

Also, while the example in which the protector 21 includes the radial portions 213 that connect one ends in the tire circumferential direction (θ direction) of the pairs of circumferential portions (first and second circumferential portions and 211 and 212) and protrude in the tire axial direction (Z direction) has been shown in the aforementioned embodiment, the present invention is not limited to this. In the present invention, as in a fifth modified example shown in FIG. 9, a protector 340 may include a radial portion 343 that connects a central part in the tire circumferential direction (θ direction) of a pair of circumferential portions (first circumferential portion 341 and second circumferential portion 342). In other words, the protector 340 may have a roughly H shape. In the fifth modified example, the protector 340 includes the first circumferential portion 341, the second circumferential portion 342, and the radial portion 343, as shown in FIG. 9. In the fifth modified example shown in FIG. 9, the dimensional relationship among length W2, length W5 and length W6 may satisfy the condition: length W6 > length W2 > length W5, similar to the embodiment shown in FIG. 4. In addition, the length W5 in the tire radial direction of the first circumferential portion 341 may be equal to the length W2 in the tire radial direction of the second circumferential portion 342. That is, the dimensional relationship may satisfy the condition: length W5 = length W2. In addition, a length L7 in the tire circumferential direction (θ direction) of the first circumferential portion 341 may be equal to the length L5 in the tire circumferential direction of the second circumferential portion 342. In addition, the length L3 in the tire radial direction (R direction) of the radial portion 343 may be smaller than the length L7 in the tire circumferential direction (θ direction) of the first circumferential portion 341 (length L7 in the tire circumferential direction of the second circumferential portion 342). That is, the dimensional relationship may satisfy the condition: length L3 < length L7.

Also, while the example in which the tire 100 is an all-season tire has been shown in the aforementioned embodiment, the present invention is not limited to this. In the present invention, the tire may be a type other than the all-season tire. For example, the tire may be a summer tire (normal tire) or winter tire (studless tire).

While the example in which the tire 100 is a pneumatic tire that supports a load using internal air pressure has been shown in the aforementioned embodiment, the present invention is not limited to this. In the present invention, the tire may be a type other than a pneumatic tire. For example, a tire may be a that includes internal support members, such as spokes, and supports a load by means of these support members.

Also, while the example in which each of the protectors 21 is formed such that a length L1 in the tire circumferential direction (θ direction) of the first circumferential portion 211, which is positioned on the inner side in the tire radial direction (R direction) in the pair of circumferential portions (first circumferential portion 211 and second circumferential portion 212), is greater than a length L2 of the second circumferential portion 212, which is positioned on the outer side in the tire radial direction, has been shown in the aforementioned embodiment, the present invention is not limited to this. In the present invention, each of the protectors may be formed such that a length in the tire circumferential direction of the first circumferential portion, which is positioned on the inner side in the tire radial direction in the pair of circumferential portions, is smaller than a length of the second circumferential portion, which is positioned on the outer side in the tire radial direction. Alternatively, each of the protectors may be formed such that a length in the tire circumferential direction of the first circumferential portion is substantially equal to a length in the tire circumferential direction of the second circumferential portion.

Also, while the example in which each of the protectors 21 is formed such that a length L3 in the tire radial direction (R direction) of the radial portion 213 is smaller than the length L1 in the tire circumferential direction (θ direction) of the first circumferential portion 211, which is positioned on the inner side in the tire radial direction (R direction) in the pair of circumferential portions (first circumferential portion 211 and second circumferential portion 212), and the length L2 in the tire circumferential direction of the second circumferential portion 212, which is positioned on the outer side in the tire radial direction, has been shown in the aforementioned embodiment, the present invention is not limited to this. In the present invention, each of the protectors may be formed such that a length in the tire radial direction of the radial portion is greater than a length in the tire circumferential direction of the first circumferential portion on the inner side in the tire radial direction and a length in the tire circumferential direction of the second circumferential portion on the outer side in the tire radial direction. Alternatively, each of the protectors may be formed such that a length in the tire radial direction of the radial portion is equal to at least one of a length in the tire circumferential direction of the first circumferential portion or a length in the tire circumferential direction of the second circumferential portion.

Also, while the example in which each of the protectors 21 is formed such that a length W1 in the tire radial direction of a part 211a on the another end 2112 side of the first circumferential portion 211, which is positioned on the inner side in the tire radial direction (R direction) in the pair of circumferential portions (first circumferential portion 211 and second circumferential portion 212), is greater than a length W2 in the tire radial direction of the second circumferential portion 212, which is positioned on the outer side in the tire radial direction, has been shown in the aforementioned embodiment, the present invention is not limited to this. In the present invention, each of the protectors may be formed such that a length in the tire radial direction of a part on the another end side of the first circumferential portion, which is positioned on the inner side in the tire radial direction in the pair of circumferential portions, is smaller than a length in the tire radial direction of the second circumferential portion, which is positioned on the outer side in the tire radial direction. Alternatively, each of the protectors may be formed such that a length in the tire radial direction of a part on the another end side of the first circumferential portion is equal to a length in the tire radial direction of the second circumferential portion.

Also, while the example in which the protector 21 is formed such that the length W3 in the tire circumferential direction (θ direction) of the radial portion 213 is greater than the length W2 in the tire radial direction (R direction) of the second circumferential portion 212, which is positioned on the outer side in the tire radial direction in the pair of circumferential portions (first circumferential portion 211 and second circumferential portion 212), has been shown in the aforementioned embodiment, the present invention is not limited to this. In the present invention, each of the protectors may be formed such that a length in the tire circumferential direction of the radial portion is smaller than a length in the tire radial direction of the second circumferential portion on the outer side in the tire radial direction. Alternatively, each of the protectors may be formed such that a length in the tire circumferential direction of the radial portion is substantially equal to a length in the tire radial direction of the second circumferential portion.

Also, while the example in which the protectors 21 are arranged between lug grooves 22 formed on the shoulder 2 in the tire circumferential direction (θ direction) has been shown in the aforementioned embodiment, the present invention is not limited to this. In other words, while the example in which each of the protectors 21 is arranged in a corresponding one of spaces between the lug grooves 22 has been shown in the aforementioned embodiment, the present invention is not limited to this. In the present invention, two or more protectors may be arranged in one of the spaces between the lug grooves. Alternatively, one or more protectors may be arranged in every other space between the lug grooves, rather than in all of the spaces.

Also, while the example in which the protectors 21 are arranged on both the shoulders 2 on both sides of the tire in the tire axial direction (Z-direction) has been shown in the aforementioned embodiment, the present invention is not limited to this. In the present invention, the protectors may be arranged only on one of the shoulders in the tire axial direction.

Also, while the example in which the protectors 21 having the same shape are provided has been shown in the aforementioned embodiment, the present invention is not limited to this. In the invention, protectors having different shapes may be provided, for example, by alternately changing their orientations.

1. A tire comprising:
a tread; and
shoulders that are arranged on outsides of the tread in a tire axial direction, wherein
a protector is or protectors are formed on each or one of the shoulders, and the protector or each of the protectors includes a pair of circumferential portions that extend in a tire circumferential direction to be spaced from each other in a tire radial direction and protrude in a tire axial direction.

2. The tire according to claim 1, wherein the protector or each of the protectors further includes a radial portion that extends in the tire radial direction to connect one ends in the tire circumferential direction of the pair of circumferential portions to each other and protrudes in the tire axial direction.

3. The tire according to claim 2, wherein the protector or each of the protectors is formed by a hook-shaped protrusion that is defined by the pair of circumferential portions and the radial portion, and opens in the tire circumferential direction.

4. The tire according to claim 2, wherein the protector or each of the protectors is formed by a roughly U-shaped protrusion that is defined by the pair of circumferential portions and the radial portion, and opens in the tire circumferential direction.

5. The tire according to claim 1, wherein the pair of circumferential portions included in the protector or each of the protectors are a first circumferential portion arranged on an inner side in the tire radial direction and a second circumferential portion arranged on an outer side in the tire radial direction; a length in the tire circumferential direction of the first circumferential portion is greater than a length in the tire circumferential direction of the second circumferential portion; and another end of the first circumferential portion further protrudes in the tire circumferential direction relative to another end of the second circumferential portion.

6. The tire according to claim 2, wherein the pair of circumferential portions included in the protector or each of the protectors are a first circumferential portion arranged on an inner side in the tire radial direction and a second circumferential portion arranged on an outer side in the tire radial direction; and a length in the tire radial direction of the radial portion is smaller than a length in the tire circumferential direction of the first circumferential portion and a length in the tire circumferential direction of the second circumferential portion.

7. The tire according to claim 1, wherein the pair of circumferential portions included in the protector or each of the protectors are a first circumferential portion arranged on an inner side in the tire radial direction and a second circumferential portion arranged on an outer side in the tire radial direction; and a length in the tire radial direction of a part on another end side of the first circumferential portion is greater than a length in the tire radial direction of the second circumferential portion.

8. The tire according to claim 7, wherein a part on the another end side of the first circumferential portion included in the protector or each of the protectors protrudes further inward in the tire radial direction relative to a part on one end side of the first circumferential portion.

9. The tire according to claim 2, wherein the pair of circumferential portions included in the protector or each of the protectors includes a second circumferential portion arranged on an outer side in the tire radial direction; and a length in the tire circumferential direction of the radial portion is greater than a length in the tire radial direction of the second circumferential portion.

10. The tire according to claim 1, wherein the protectors are arranged between lug grooves formed on the shoulder in the tire circumferential direction.

11. The tire according to claim 10, wherein the protectors are formed on the shoulder within ranges from a ground contact edge of the tread to edges of the lug grooves.

12. The tire according to claim 1, wherein the protector or each of the protectors has a protruding thickness from not smaller than 0.5 mm to not greater than 2 mm the tire axial direction.
